(19) United States
(12) Patent Application Publication
(10) Pub. No.: US 2013/0339605 A1
(43) Pub. Date: Dec. 19, 2013

(54) UNIFORM STORAGE COLLABORATION AND ACCESS

(71) Applicants: Michael Factor, Haifa (IL); Boaz Mizrachi, Haifa (IL); Gal Shachor, Yokneam (IL)

(72) Inventors: Michael Factor, Haifa (IL); Boaz Mizrachi, Haifa (IL); Gal Shachor, Yokneam (IL)

(73) Assignee: INTERNATIONAL BUSINESS MACHINES CORPORATION, Armonk, NY (US)

(21) Appl. No.: 13/526,555

(22) Filed: Jun. 19, 2012

(51) Int. Cl. G06F 12/08; G06F 12/00; G06F 12/06

(52) U.S. Cl. 711/118; 711/170; 711/154; 711/E12.017; 711/E12.084; 711/E12.001

(57) ABSTRACT

A computerized method of collaborating storage space across multiple devices according to file usage patterns of the devices. The method comprises receiving access to a plurality of storage media each having a storage space and managed by at least one of a plurality of devices, identifying for each of the plurality of devices at least one usage pattern of at least one of a plurality of file types, creating a virtually contiguous storage pool mapping physical memory addresses of the plurality of storage media, setting a file distribution policy of storing each of a plurality of data files stored in the plurality of storage media in the virtually contiguous storage pool according to a match between a file type and at least one usage pattern, and collaborating storage space across the plurality of storage media managed by the plurality of devices according to the file distribution policy.

### BACKGROUND

The present invention, in some embodiments thereof, relates to storage systems and, more specifically but not exclusively, to distributed storage systems spanned across multiple devices.

A single user often carries and uses a number of static computing devices such as personal computers, as well as a diverse collection of mobile electronic devices such as smart phones, music players, tablets, and laptops. Such mobile electronic devices offer advanced computing and connectivity abilities, but are equipped with limited storage space.

Duplication and manual synchronization of data files are common storage practices across multiple storage media. These practices are often unreliable and consume excess storage space on some or all of the mobile devices.

Cloud services may be used to expand storage space of mobile devices, but may consume significant resources such as battery power, network bandwidth or the like. Usage of cloud services may introduce device compliance challenges, as well as expose data sent to and received from the cloud to security and integrity risks.

Other options include external, USB-attached storage devices which offer mass storage on a separate file system. Accessing data on such devices typically requires an external power source.

### SUMMARY

According to an aspect of some embodiments of the present invention there is provided a computerized method of collaborating storage space across multiple devices. The method comprises receiving access to a plurality of storage media each having a storage space and managed by at least one of a plurality of devices, identifying for each of the plurality of devices at least one usage pattern of at least one of a plurality of file types, creating a virtually contiguous storage pool mapping physical memory addresses of the plurality of storage media, setting a file distribution policy of storing each of a plurality of data files stored in the plurality of storage media in the virtually contiguous storage pool according to a match between a file type and the at least one usage pattern, and collaborating, using a processor, storage space across the plurality of storage media managed by the plurality of devices according to the file distribution policy.

According to an aspect of some embodiments of the present invention there is provided a computerized method of retrieving data from collaborated storage space spanned across a plurality of devices. The method comprises receiving a file distribution policy of locating a plurality of data files in a virtually contiguous storage pool spanned across a plurality of storage media and managed by the plurality of devices, receiving from a device selected from the plurality of devices a data request for a file, searching, using a processor, for the file in at least one storage medium selected from the plurality of storage media according to the file distribution policy, and retrieving the file from the at least one storage medium.

According to an aspect of some embodiments of the present invention there is provided a system for collaborating storage space across multiple devices. The system comprises a processor, an interface module which receives access to a plurality of storage media each having a storage space and managed by at least one of a plurality of devices, a usage pattern recognition module which identifies for each of the plurality of devices at least one usage pattern of at least one of a plurality of file types, a storage collaboration module which creates a virtually contiguous storage pool mapping physical memory addresses of the plurality of storage media, a file distribution policy module which sets a file distribution policy of storing each of a plurality of data files in the virtually contiguous storage pool according to a match between a file type and the at least one usage pattern, and a file storage, search and retrieval module which collaborates storage space across the plurality of storage media managed by the plurality of devices according to the file distribution policy.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a computerized method for transparently collaborating storage space across multiple devices, according to some embodiments of the present invention;

FIG. 2 is a relational view of software and hardware components of a system for transparently collaborating storage space across multiple devices, according to some embodiments of the present invention;

FIG. 3 is a schematic diagram illustrating file mapping to storage media according to usage patterns of devices, according to some embodiments of the present invention;

FIG. 4 is a flowchart of a computerized method for transparently retrieving data from collaborated storage space spanned across a plurality of devices, according to some embodiments of the present invention, and

FIG. 5 is a relational view of software and hardware components of an enhanced system for transparently collaborating storage space across multiple devices, according to some embodiments of the present invention

### DETAILED DESCRIPTION

The present invention, in some embodiments thereof, relates to storage systems and, more specifically but not exclusively, to distributed storage systems spanned across multiple devices.

According to some embodiments of the present invention, there are provided methods and systems of leveraging combined storage capabilities of multiple mobile, static and cloud storage media to create a virtually contiguous storage space with a uniform file system. The systems and methods enable users to fully utilize a combined data storage space spanned across multiple storage media managed by multiple devices.

Embodiments of the present invention are typically used on storage media managed by multiple devices which are accessible to a common user. The systems and methods utilize usage patterns typical to each of the devices to determine a file distribution policy of storing data files in a manner which forms contiguous storage pools which span across multiple devices according to the identified usage patterns. The file distribution policy is also used by devices to retrieve files according to availability data of the storage medium and/or the file attributes.

Embodiments of the present invention use a uniform file system namespace, which allows devices in typical mobile settings to access large files or portions of large files which are stored on remote storage media, thus preventing local data storage overflow. De-duplication techniques are used to reduce the amount of duplicated data across multiple storage media, thus conserving storage space and reducing the need for file synchronization between multiple storage media. Local caching and pre-fetching of data files according to device usage patterns may be used to improve user experience in terms of file retrieval speed, file availability and avoidance of network related delays.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

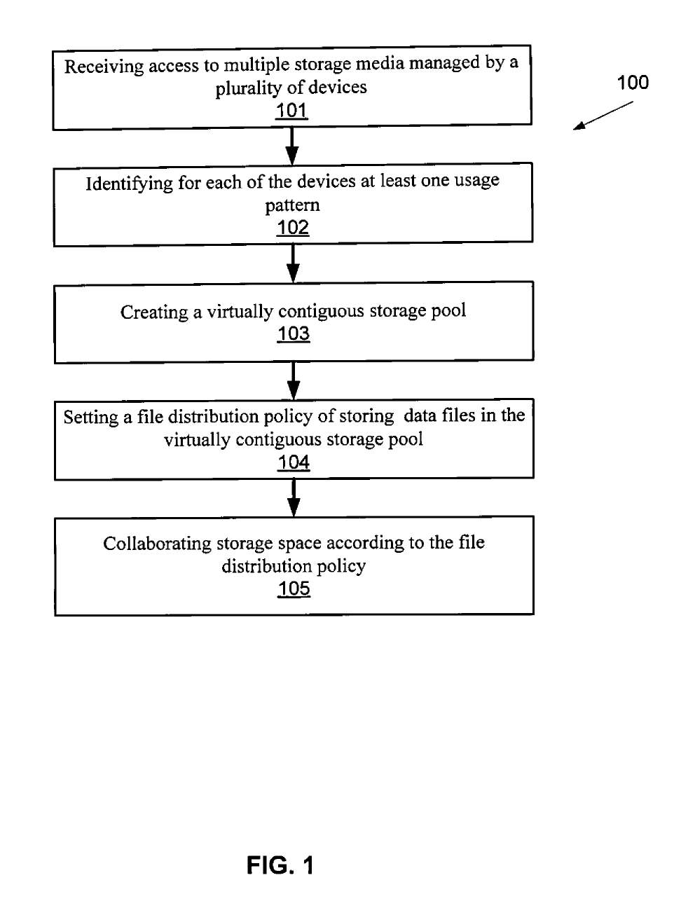

Reference is now made to FIG. 1, which is a flowchart of a computerized method 100 for transparently collaborating storage space across multiple devices, according to some embodiments of the present invention. The method enables mapping of files to a virtually contiguous storage space across multiple storage media managed by one or more devices. The mapping of files by each of the devices is performed according to individual usage patterns of files, according to availability data of files and storage media.

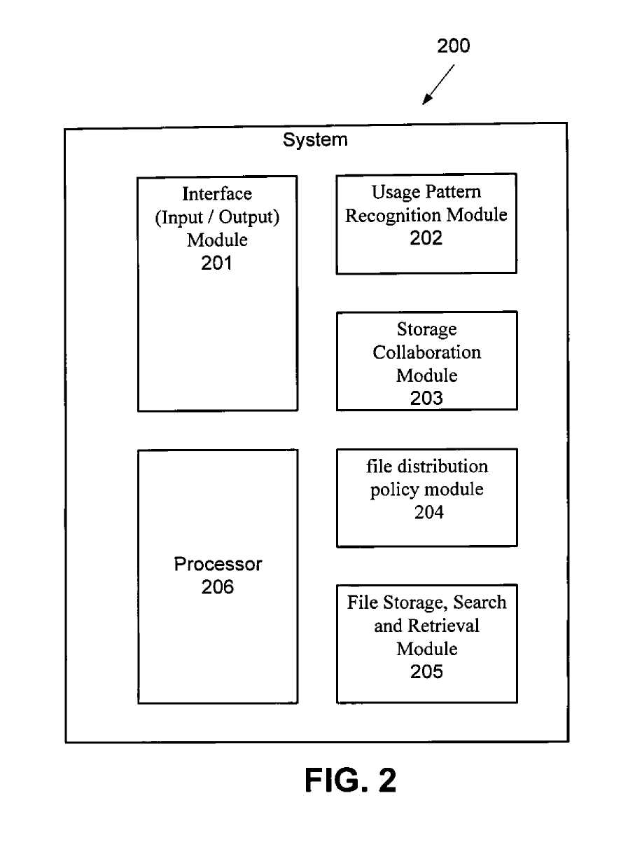

Reference is also made to FIG. 2, which is a relational view of software and hardware components of a system for transparently collaborating storage space across multiple devices, according to some embodiments of the present invention.

The system 200 includes an interface serving as an input and/or output module 201, a usage pattern recognition module 202, a storage collaboration module 203, a file distribution policy module 204, a file storage, search and retrieval module 205, and a processor 206. For brevity, it should be noted that computing functions described herein may be performed using the processor 206.

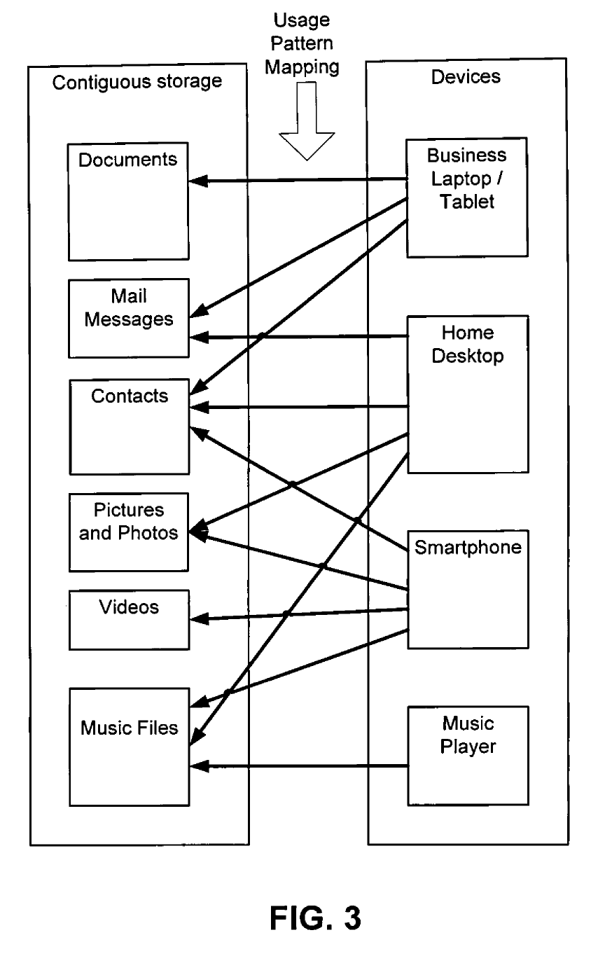

System 200 enables devices having distinct usage patterns to share a virtually contiguous storage space spanned across multiple storage media using a single file system. The mapping of files within the virtually contiguous storage space is demonstrated in FIG. 3, which is a schematic diagram illustrating electronic device file mapping to storage media according to usage patterns of the devices, according to some embodiments of the present invention.

The method 100 and system 200 may be implemented as a networking platform, an add-on to an existing networking platform, and/or as a software as a service (SaaS) which provides services for users via client terminals.

As shown at numeral 101 of FIG. 1, first, the interface 201 acquires, for example receives or accesses, access data to multiple storage media each managed by one or more electronic devices which use and/or store different files on one or more of the storage media. For example, the interface may acquire access to three storage media, out of which two storage disks each having a storage capacity of 500 gigabyte locally residing on and managed by a laptop computer for storage of documents, pictures and music files, and another storage disk having a capacity of 50 gigabyte locally residing on and used by a music player to store music files to be played by the music player. The access data to the storage media may be received as a file, indicated by a link to a file, scanned from a document, and/or the like.

The interface may acquire a fixed set of storage media available and connected at all times, or a dynamic set of storage media. Availability of a storage medium may be determined according to power consumption, network connectivity, or usage patterns of the device which hosts the storage medium.

As shown at 102, the usage pattern recognition module 202 identifies one or more usage patterns for each of the devices. Each usage pattern associates between a device and one or more file types commonly used by the device. The term “usage” as referred to herein may include reading data from a file, modifying a file, copying a file or the like. For example, a typical usage pattern may map a music player to music and sound file types. Other exemplary usage patterns may map tablet or laptop computers to movie file types, smart phones and laptops to contact and mail file types, or the like.

Identifying usage patterns of devices may be performed, for example and without limitation, by tracking files having common properties, which are often used by the device, for example files having “.wav” or “.mp3” extensions used by the music player. Additionally and alternatively, the usage pattern recognition module 202 may employ prediction algorithms based on statistical analysis of file usage data to detect device usage patterns. Prediction algorithms may be based on file usage frequency, or based on devices' intended primary use—for example matching of movie files to an iPad or MP3 music files to a music player.

As shown at numeral 103 of FIG. 1, the storage collaboration module 203 creates one or more virtually contiguous storage pools from the multiple storage media. Each storage pool maps physical memory addresses of storage media to a virtual memory space shared across all storage media and devices. Virtual memory management techniques allow a single interface for accessing various forms of computer data storage (such as random-access memory and disk storage) hosted on different devices which may differ in architecture. The virtually contiguous storage pool spanned across multiple devices enhances the storage access concepts and techniques developed for multitasking kernels, which allows computer data storage to be shared such that a program may be designed as though there is only one kind of memory which behaves like directly addressable read/write memory (RAM).

In some embodiments, a single virtually contiguous storage pool is used for all file types and/or file access requests. In other embodiments, different virtually contiguous storage pools are created according to different usage types, for example one virtually contiguous storage pool for music files and another for document files. Each virtually contiguous storage pool may span across one or more storage media.

As shown at numeral 104 of FIG. 1, the file distribution policy module 204 generates a file distribution policy of storing each data file in one or more virtually contiguous storage pools according to identified usage patterns. The file distribution policy may consider availability data of storage media in the creation of the file distribution policy. Availability data may be related to the storage medium, file attributes or the like. Storage medium data may include connection speed, physical proximity of the storage medium to the device requesting a file operation, resource availability state or the like. Typical file attributes of the requested file may include the file's usage type, size, timestamp, security attributes, author or the like.

In some embodiments, the file distribution policy may dictate migration and/or duplication of one or more data files between different storage media. Migration may be local or remote, involving one or more storage media, and optionally include duplication and/or conflict resolution of the migrated files. Resolving detected conflicts may include merging file instances, discarding file instances and/or deleting file instances. Such operations may be performed automatically or involve user interaction(s), for example by raising an alert to a user requesting specific instructions and/or approval.

Enabling local and remote migration of files according to the file distribution policy may require establishment of secure association between devices which allows storage space collaboration between the storage media hosted by the devices.

Local migration may be triggered by a file request originating from a source device, and cause data files to be imported to or exported away the storage media hosted on the local source device. In local migration, one or more of the source and the destination storage medium is hosted on the source device.

Upon a file import operation, the requested data file and/or a duplicated replica of the requested data file is migrated from a data storage medium located on a remote device to a data storage medium located on the source device. Upon a file export operation, the requested data file and/or a duplicated replica of the requested data file is migrated from a data storage medium located on the source device to a data storage medium located the on a remote device, away from the source device.

In remote migration, both the source and the destination storage media are hosted on the one or more remote target device. In such cases, files may be imported to and exported from a storage media hosted by a target device which did not initiate a file request or take part in using the file.

In some embodiments, the file distribution policy dictates local and/or remote migration of a file according to the file's attributes. Additionally and alternatively, the file distribution policy may dictate migration according to affinity of the device which hosts storage media involved in the migration to one or more other devices having a usage pattern relevant to the file. Migration may be dictated according to a rating, in which one or more scores are assigned to each storage medium, according to the storage medium's affinity with devices which host storage media in the collaborated virtually contiguous storage pool. Each affinity score may be calculated according to attributes such as physical proximity of the storage medium to a device, the network speed between the storage medium and a device, availability of the storage medium to a device, or the like. An overall rating for each device may be calculated according to the assigned one or more scores.

The selection of a file distribution policy may further provide efficient use of resources such as wireless connectivity and/or power consumption of mobile devices. In the case of wireless connectivity, the policy may take into account data such as costs and data exchange quotas according to network providers, geographical locations or the like.

Last, as shown at numeral 105 of FIG. 1, the file storage, search and retrieval module 205 collaborates storage space which is spanned across multiple storage media according to the file distribution policy. This may be implemented by providing a single file namespace across all storage media representing the virtually contiguous storage pool.

In some embodiments, the file storage, search and retrieval module 205 maps requests for search file, read file, and write file operations from the virtually contiguous storage pool to a specific storage medium on which the requested file is stored. Input and/or output module 201 may be used to provide a user interface or application programming interface (API) to generate requests which are processed within the file storage, search and retrieval module 205.

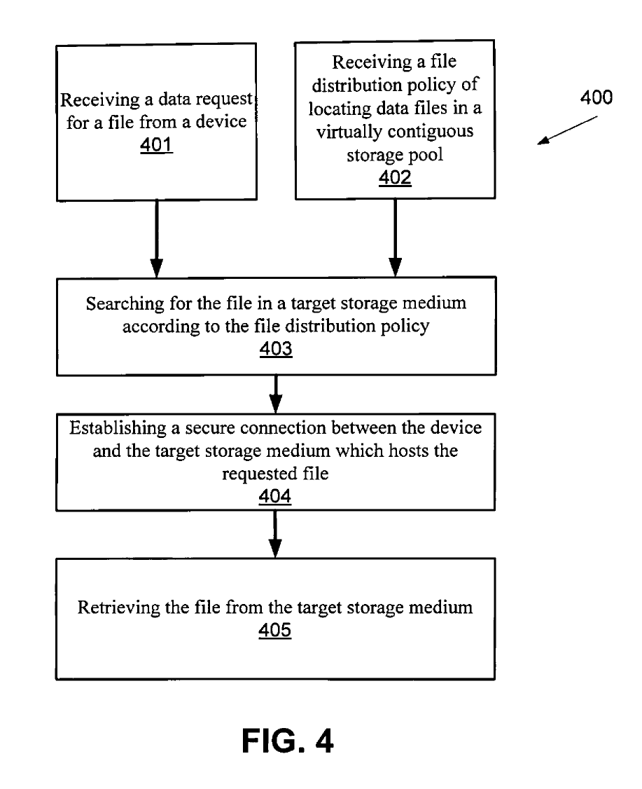

Reference is now made to FIG. 4, which is a flowchart of a computerized method 400 for transparently retrieving data from collaborated storage space spanned across a plurality of devices, according to some embodiments of the present invention.

As shown at numerals 401 and 402 of FIG. 4, first, the interface module 201 receives a data request for a file from a device, and a file distribution policy of locating data files in a virtually contiguous storage pool 402.

As shown in at numeral 403 of FIG. 4, the file storage, search and retrieval module 205 searches for the file in a target storage medium according to the file distribution policy. Instances of the file may be located in a single storage medium or in multiple storage media, in which case the file storage, search and retrieval module 205 applies optimization techniques of fetching the file according to criteria such as maximizing the retrieval speed or minimizing resource consumption such as but not limited to bandwidth or power. Other criteria such as availability or proximity of the storage medium to the device may also be considered when selecting a data exchange protocol.

As shown at numeral 404 of FIG. 4, in some embodiments, the file storage, search and retrieval module 205 establishes a secure connection between the device and the target storage medium which hosts the requested file. The secure connection may be based on authentication of machine, user or the like to create mutual trust between the device requesting the file and the storage medium hosting the requested file. Establishing a secure connection may include negotiating trust between the device and a target storage medium according to one or more of security data provided by the device and access rights to the requested file provided by the target storage medium which stores the requested file. For example, device security data may be constructed from a combination of device credentials and user credentials. A match between device security data and file access rights as provided by the hosting storage medium may be a pre-requisite for file access, retrieval, deletion or the like.

When file retrieval and/or data exchange are performed across relatively short distances, open wireless technology standards for exchanging data over short distances may be utilized, such as but not limited to Bluetooth pairing data exchange using short wavelength radio transmissions from fixed and mobile devices. Such data exchange protocols may be used for the data exchange as they create momentary personal area networks (PANs) with high levels of trust and security.

Last, as shown at numeral 405 of FIG. 4, the file storage, search and retrieval module 205 retrieves the file from the target storage medium.

Alerts may be generated by devices hosting a storage medium with regard to its availability, for example when a mobile device is about to run out of battery power and not be able to provide access to the storage media it hosts. The interface module 201 may actively query and/or receive the availability status of each of the devices hosting the different storage medium. The storage collaboration module 203 may act as a central storage management module, and perform changes in file storage and file distribution policy to accommodate availability of storage devices. Mechanisms such as distributed hash table (DHT) or other existing central storage management technologies may be used for distributed management of storage media availability.

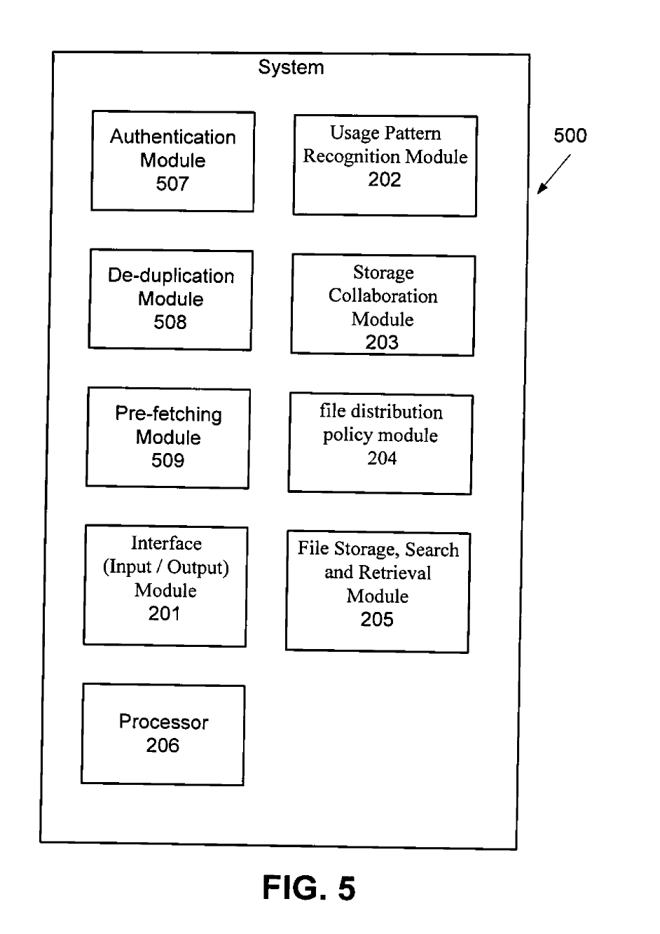

Reference is made to FIG. 5, which is a relational view of software and hardware components of an enhanced system 500 for transparently collaborating storage space across multiple devices, according to some embodiments of the present invention. The system comprises the components of system 200, along with one or more of an authentication module 507, a de-duplication module 508 and a pre-fetching module 509. For brevity, it should be noted that computing functions described herein may be performed using the processor 206.

The authentication module 507 negotiates multi-directional trust between devices and storage media which form the collaborated virtually contiguous storage pool. Trust establishment may include multi-way authentication of security data provided by one or more of the devices, users and storage media. Trust may be a pre-requisite for approval of additional devices and storage media into the virtually contiguous storage pool.

Local caching and pre-fetching techniques may be used to increase file retrieval performance. In some embodiments, the pre-fetching module 509 identifies files related to the original data file request sent by the device. The pre-fetching module 509 may send consequent data requests for the identified related files to the file storage, search and retrieval module 205. Prediction algorithms may be employed to provide a forecast of future related files which may be requested by a device. Such related files may be identified for example and without limitation according to request patterns of the user and/or request patterns of the device.

Consequent data requests for at least one related file identified according to a usage pattern of the device and/or a request pattern may be sent by the device, such that the files are pre-fetched and ready for local use on the device without explicit intervention of the user.

Pre-fetching and local caching may trigger migration and/or copying file instances across multiple storage media. As such, local caching may introduce conflicts in file instances stored across multiple media. The de-duplication module 508 may track instances of data files in the virtually contiguous storage pool and resolve conflicts between the instances to create a consistent, reliable user experience.

Full de-duplication of file instances may not be possible at all times. The de-duplication module may track concurrent updates of instances of a file on multiple instances of files, and use approaches such as semi-synchronization to resolve detected conflicts between instances of a file. Conflict resolution may be performed transparently and automatically by merging the instances, discarding instances, or alternatively includes alerting mechanism to alert a user regarding conflicts and asking for approval in the conflict resolution process.

Embodiments of the systems and methods allow devices in typical mobile settings simple and substantially transparent access to files stored in a virtually contiguous storage pool, even if the files are physically stored on a storage medium hosted on a remote device. A file distribution policy may be set according to attributes such as but not limited to network and device availability, connectivity speed, or network usage cost, which contribute to efficient, quick access to data stored in multiple storage media spanned across multiple devices. Local caching and file migration contribute to high availability of data files, and de-duplication techniques are used to conserve overall available storage space in the virtually contiguous storage pool.

Recognition of user and device usage patterns and their employment in setting a file distribution policy improves user experience in terms of file retrieval speed, file availability and avoidance of network related delays. The use of a uniform file system namespace prevents local data storage overflow, file duplication across multiple storage media, and reduces the need for file synchronization between multiple storage media. Storage space can be efficiently shared even in a dynamic environment where availability of devices which host storage media is frequently updated.

Devices having local storage media in such settings typically comprise a file collaboration module which collaborates the storage space of the local media with that of remote storage media. The created virtually contiguous storage pool includes the collaborated mapping of physical memory addresses of local and remote storage media.

The methods as described above are used in the fabrication of integrated circuit chips.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms event processing networks and simulations is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of collaborating storage space across multiple devices comprising:
receiving access to a plurality of storage media each having a storage space and managed by at least one of a plurality of devices;
identifying for each of said plurality of devices at least one usage pattern of at least one of a plurality of file types;
creating a virtually contiguous storage pool mapping physical memory addresses of said plurality of storage media;
setting a file distribution policy of storing each of a plurality of data files stored in said plurality of storage media in said virtually contiguous storage pool according to a match between a file type and said at least one usage pattern; and
collaborating, using a processor, storage space across said plurality of storage media managed by said plurality of devices according to said file distribution policy.

2. The method of claim 1, further comprising migrating at least some of said plurality of data files between said plurality of storage media.

3. The method of claim 2, wherein said setting a file distribution policy comprises migration of at least one of said plurality of data files to a storage medium selected from said plurality of storage media and managed by a target device selected from said plurality of devices according to affinity of said storage medium and said target device.

4. The method of claim 1, wherein said collaborating storage space comprises establishing a secure association between said plurality of devices.

5. The method of claim 1, wherein said creating a virtually contiguous storage pool comprises migrating at least one of said plurality of data files between said plurality of storage media.

6. The method of claim 5, further comprising erasing at least one duplicate copy of said at least one of said plurality of data files from at least one of said plurality of storage media.

7. A computerized method of retrieving data from collaborated storage space spanned across a plurality of devices, the method comprising:
receiving a file distribution policy of locating a plurality of data files in a virtually contiguous storage pool spanned across a plurality of storage media and managed by said plurality of devices;
receiving from a device selected from said plurality of devices a data request for a file;
searching, using a processor, for said file in at least one storage medium selected from said plurality of storage media according to said file distribution policy; and
retrieving said file from said at least one storage medium.

8. The method of claim 7, wherein searching for said file comprises providing a rating for each of said at least one storage medium according to availability data of said file on each of said at least one storage medium;
wherein retrieving said file comprises selecting a target storage medium from said at least one storage medium according to said rating.

9. The method of claim 8, wherein said availability data of said file on each of said at least one storage medium is collected according to at least one of storage medium data and file data.

10. The method of claim 9, wherein said storage medium data is selected from a group consisting of: a connection speed between said at least one storage medium and said device, a physical proximity of said at least one storage medium and said device, a resource usage efficiency of said at least one storage medium, and availability of said at least one storage medium.

11. The method of claim 9, wherein said file data is selected from a group consisting of: a file type, a file size, a file timestamp, a file security attributes, and a file author.

12. The method of claim 8, wherein retrieving said file comprises establishing a secure connection between said device and said target storage medium.

13. The method of claim 12, wherein said establishing a secure connection comprises negotiating trust between said device and said target storage medium according to at least one of security data provided by said device and access rights to said file provided by said target storage medium.

14. The method of claim 13, wherein said security data comprises at least one of user credentials and device credentials exchanged between said device and said target storage medium.

15. The method of claim 7, wherein said retrieving said file from said at least one storage medium comprises local caching of said file on a storage medium managed by said device.

16. The method of claim 15, wherein said local caching comprises tracking concurrent updates of instances of said file on said at least one storage medium and said storage medium managed by said device, and resolving detected conflicts between said instances of said file.

17. The method of claim 16, wherein said resolving detected conflicts comprises at least one of merging said instances of said file and discarding at least one instance selected from said instances of said file.

18. The method of claim 16, wherein said resolving conflicts between said instances of said file comprises alerting a user regarding detected conflicts between said instances of said file.

19. The method of claim 7, further comprising searching in said at least one storage medium for at least one related file identified according at least one of consequent data requests for said at least one related file made by said device and a request pattern of said device, and retrieving said related file from said at least one storage medium.

20. A computer program product for collaborating storage space across multiple devices, said computer program product comprising:
a computer readable storage medium;
first program instructions to receive access to a plurality of storage media each having a storage space and managed by at least one of a plurality of devices;
second program instructions to identify for each of said plurality of devices at least one usage pattern of at least one of a plurality of file types;
third program instructions to create a virtually contiguous storage pool mapping physical memory addresses of said plurality of storage media;
fourth program instructions to set a file distribution policy of storing each of a plurality of data files stored in said plurality of storage media in said virtually contiguous storage pool according to a match between a file type and said at least one usage pattern; and
fifth program instructions to collaborate storage space across said plurality of storage media managed by said plurality of devices according to said file distribution policy;
wherein said first, second, third, fourth and fifth program instructions are stored on said computer readable storage medium.

21. A system for collaborating storage space across multiple devices, comprising:
a processor;
an interface module which receives access to a plurality of storage media each having a storage space and managed by at least one of a plurality of devices;
a usage pattern recognition module which identifies for each of said plurality of devices at least one usage pattern of at least one of a plurality of file types;
a storage collaboration module which creates a virtually contiguous storage pool mapping physical memory addresses of said plurality of storage media;
a file distribution policy module which sets a file distribution policy of storing each of a plurality of data files in said virtually contiguous storage pool according to a match between a file type and said at least one usage pattern; and
a file storage, search and retrieval module which collaborates storage space across said plurality of storage media managed by said plurality of devices according to said file distribution policy.

22. The system of claim 21, further comprising an authentication module which negotiates trust between said plurality of devices and said plurality of storage media according to at least one of security data provided by said plurality of devices and access rights to said file provided by said plurality of storage media.

23. The system of claim 21, further comprising a de-duplication module which tracks instances of each of said plurality of data files in said virtually contiguous storage pool and resolves conflicts between said instances.
